(19) United States
(12) Patent Application Publication
(10) Pub. No.: US 2026/0366663 A1
(43) Pub. Date: Nov. 19, 2026

(54) MULTI-CONNECTOR SYSTEM

(71) Applicant: STAUBLI FAVERGES, Faverges-Seytherex (FR)

(72) Inventors: Jérôme Perroud, Saint Jorioz (FR); Philippe Guin, Annecy (FR)

(21) Appl. No.: 19/663,879

(22) Filed: Apr. 30, 2026

(30) Foreign Application Priority Data
May 15, 2025 (FR) 2505174

(51) Int. Cl. F16L 37/56; F16L 37/32

(52) U.S. Cl. CPC F16L 37/56; F16L 37/32

(57) ABSTRACT

A first subassembly of the multi-connector system comprises a first plate, several connector elements and two pins. A second subassembly comprises a second plate, several connector elements and an operating lever, with two side plates each provided with a groove for receiving a pin. Plates are devoid of specific pre-positioning means. A mouth of a female connector element comprises a first centering portion having a first diameter and a second sealing portion having a second diameter strictly smaller than the first diameter. When side plates are in the release position and pins abut against entry zones of the grooves, a tubular nose of a male connector element is received in first portion of mouth, without being engaged in second portion of this mouth.

### FIELD

The present invention relates to a multi-connector system for the simultaneous connection of fluid circuits, by means of male and female connector elements.

### BACKGROUND

In the plastics processing field, it is known to group on a first plate, often called a “supply plate,” female connector elements and, on a second plate, often called a “receiving plate,” male connector elements, this in order to be able to connect, in a single operation of moving the first and second plates toward one another, several thermal regulation fluid circuits of plastic injection molds.

Generally, the supply plate groups together between four and twelve female connector elements connected to fluid circuits, as well as a male pre-positioning member, such as a central column, and means for moving together and locking the plates in a configuration of connection of the fluid circuits. For its part, the receiving plate, which is generally integral with an injection mold, groups together between four and twelve male connector elements complementary to the female connector elements of the supply plate and connected to fluid circuits, as well as a female pre-positioning member, such as a centering bushing, and means for moving together and locking complementary to the first means for moving together and locking of the supply plate.

During the connection of the female and male connector elements respectively supported by the supply plate and the receiving plate, a first pre-positioning step takes place, during which the operator places the supply plate opposite the receiving plate and moves them toward one another, so as to align these plates on a connection axis. The operator is assisted by the penetration of the end of the centering column into the centering bushing. In a second step, the operator proceeds with moving the plates together, by actuating the moving-together means. During this step, and in particular at the very beginning of this step, the female connector elements align with the male connector elements under the action of the centering members, then any valves of these connector elements are pushed back to open the fluid circuits. Moving the plates together during this second step requires a relatively substantial force for moving together. This requirement is fully satisfied by the locking block of the multi-connector system marketed by the company STAUBLI under reference RMI Multi, which is actuated by means of a lever. Although globally satisfactory, this locking block has a relatively large footprint on the supply plate and requires a large free volume to allow manipulation of the lever. This tends to limit the installation density of the connector elements on the supply and receiving plates.

Moreover, it is known from ITMI940559A1 to equip a multi-connector system with an operating lever comprising two lateral side plates articulated on one of the plates and fastened together by a bar. Each of the side plates has a groove for receiving a pin integral with the other plate. This operating lever has no footprint on the installation surface of the connector elements. In this known multi-connector system, pre-positioning and guiding columns and bushings must be used to pre-position the male and female connector elements relative to one another during a movement of approach of the supply and receiving plates. This multi-connector system remains cumbersome, in particular because the installation surface of the connector elements must be sufficiently large to install there, in addition to the connector elements, the two pre-positioning, guiding and centering columns and the corresponding pre-positioning, guiding and centering bushings, which are indispensable for the correct positioning of the plates during the connection of the corresponding fluid circuits.

It is also known from EP0390715B1 to provide, on two plates of a multiple fluid connector, edges that cooperate with one another to guide the two plates toward one another, when they are moved together to connect male and female fluid connection elements carried by these plates. These edges induce bulk problems analogous to those of ITMI940559A1.

### SUMMARY

Preferably, the invention is directed to the simultaneous connection of several thermoregulation circuits, that is to say circuits in which one or more heat-transfer fluids circulate.

It is these drawbacks mentioned in the background section that the invention more particularly intends to remedy by proposing a new multi-connector system whose compactness is improved compared to existing equipment.

For this purpose, the invention relates to a multi-connector system for the simultaneous connection of fluid circuits along a connection axis, by means of male and female connector elements, this multi-connector system comprising a first subassembly including a first plate, several first connector elements installed in housings of the first plate and two pins extending along a first transverse axis perpendicular to the connection axis and arranged symmetrically on two opposite sides of the first plate. The multi-connector system also comprises a second subassembly including a second plate, several second connector elements, complementary to the first connector elements, installed in housings of the second plate and configured to connect to the first connector elements of the first subassembly, in order to connect the fluid circuits to one another and an operating lever equipped with two lateral side plates articulated on the second plate about an articulation axis perpendicular to the connection axis, each having a groove for receiving and sliding of a pin of the first subassembly and movable in rotation about the articulation axis, between a locking position, in which the pins are locked in the grooves and the fluid circuits are connected to one another, and a release position, in which the first subassembly and the second subassembly can be moved away from one another along the connection axis. A distal end of each male connector element comprises a cylindrical tubular nose.

According to the invention, the first plate and the second plate are devoid of specific means for pre-positioning, guiding or centering a movement of approach of the first and second plates during the connection of the first and second subassembly. A mouth of a female connector element comprises a first centering portion having a first diameter and a second sealing portion having a second diameter, the second diameter being strictly smaller than the first diameter. When the side plates of the operating lever are in the release position and the pins abut against entry zones of the grooves of the side plates, the tubular nose of a male connector element is received in the first portion of the mouth of a female connector element, without being engaged in the second portion of this mouth.

Thanks to the invention, the absence of specific means for pre-positioning, guiding or centering makes it possible to install the male and/or female connector elements with a high density. This improves the compactness of the multi-connector system. Furthermore, any jamming problems are resolved by the fact that the mouth of the female connector element comprises two portions of different diameters, which serve respectively for pre-centering the male element and for sealing engagement. In the configuration where the side plates are in the release position and the pins abut against the entry zones of the grooves, there is no risk of sticking or jamming of the nose of a male element in the mouth of the female element because the diameter of the first centering portion of the mouth can be sufficiently large to allow a possible centering defect that is compensated for by the action of the operating lever when the pins engage in the grooves of the side plates.

According to advantageous but non-mandatory aspects of the invention, such a multi-connector system may incorporate one or more of the following features, taken according to any technically admissible combination(s):

A surface of a subassembly that is the farthest from a front face of the plate of this subassembly is formed by a distal surface of the nose of a male connector element or by a distal surface of the mouth of a female connector element.

Each side plate comprises a beak that laterally delimits a mouth of the groove of the side plate and in which, when the operating lever is in the release position and abutting against the pins of the first subassembly, the beak of each side plate bears against a pin, by defining a first value of a separation distance of the first and second plates along the connection axis.

The connector elements are mounted with radial play in the housings of the first plate and/or of the second plate. The radial play between the connector elements and the housings allows an adjustment of the position of the connector elements relative to the first and second plates, during connection.

The housings of the two plates are arranged asymmetrically relative to a median plane of the plates containing the transverse axis and the connection axis. The asymmetrical arrangement of the housings of the two plates, therefore of the connector elements that are received therein, induces that there is only one possible direction of connection of the subassemblies.

A female connector element comprises a valve biased into a closed position by an elastic return member and pushed into an open position by the complementary male element when the side plates of the operating lever are moved from their release position toward their locking position and, preferably, a male connector element comprises a valve biased into a closed position by an elastic return member and pushed into an open position by the complementary female element, when the side plates of the operating lever are moved from their release position toward their locking position. The fact of having valves in the connectors on the supply assembly side avoids having to drain the fluid circuits connected to this assembly during disconnection of the connector elements. The fact of having valves on the receiving assembly side avoids having to drain the fluid circuits connected to this subassembly, during a disconnection.

At least one articulation of the operating lever on the second plate is equipped with means for braking the rotation of the operating lever about the articulation axis. Thanks to this aspect of the invention, the operating lever is stable in its release position.

For each pair of complementary connector elements, the housing for installing the first connector element in the first plate is identical to the housing for installing the second connector element in the second plate. Manufacture of the first and second plates is thus facilitated.

The first and second plates are identical. Thanks to this aspect of the invention, the multi-connector system can be easily adapted to its configurations of use.

The first connector elements are male connector elements and the second connector elements are female connector elements or the first connector elements comprise both male connector elements and female connector elements and the second connector elements comprise both female connector elements and male connector elements. Thanks to this aspect of the invention, the multi-connector system can be easily adapted to its configurations of use.

The first plate and the second plate each carry between four and twelve connector elements. Thanks to this aspect of the invention, the multi-connector system is suited to most configurations of use.

This multi-connector system comprises a foolproofing device for the relative orientation of the first and second plates around the connection axis, this foolproofing device including two strips of complementary shapes each mounted on one side of the first and second plates. Thanks to this aspect of the invention, the safety of use of the multi-connector system is improved.

The pins are fixed on the first plate, preferably on an edge of this plate, and members materializing the articulation axis of the lateral side plates are fixed on the second plate, preferably on an edge of this plate.

### BRIEF DESCRIPTION OF THE DRAWINGS

The invention will be better understood and other advantages thereof will appear more clearly in light of the following description of several embodiments of a multi-connector system according to its principle, given by way of example and made with reference to the appended drawings in which:

FIG. 1 is a perspective view of a multi-connector system according to the invention, in a configuration during a movement bringing together two subassemblies of this system, along a connection axis.

FIG. 2 is a perspective view of the multi-connector system of FIG. 1 in the coupled configuration of its connector elements.

FIG. 3 is an end view of the system of FIGS. 1 and 2 in the direction of arrow III in FIG. 1, when the system is in a pre-connection configuration, intermediate between those respectively shown in FIGS. 1 and 2.

FIG. 4 is a partial sectional view along line IV-IV in FIG. 3.

FIG. 5 shows on two insets A) and B), views analogous to FIGS. 3 and 4, on a smaller scale and when the system is in an intermediate configuration between that of FIGS. 3 and 4 and that of FIG. 2.

FIG. 6 shows on two insets A) and B) views analogous to that of FIG. 5 when the system is in the coupled configuration of FIG. 2.

FIG. 7 shows, on inset A), a partial sectional view along line VII on inset A) of FIG. 6 and, on inset B), a section analogous to inset B) of FIG. 6 for a second embodiment.

FIG. 8 shows, on inset A), a partial exploded view of a system according to a third embodiment of the invention and, on inset B), a view analogous to FIG. 1 for a system according to a fourth embodiment.

FIG. 9 shows a view analogous to FIG. 1 for a system according to a fifth embodiment of the invention; and

FIG. 10 shows, on two insets A) and B), two perspective views of a system according to a sixth embodiment of the invention.

### DETAILED DESCRIPTION

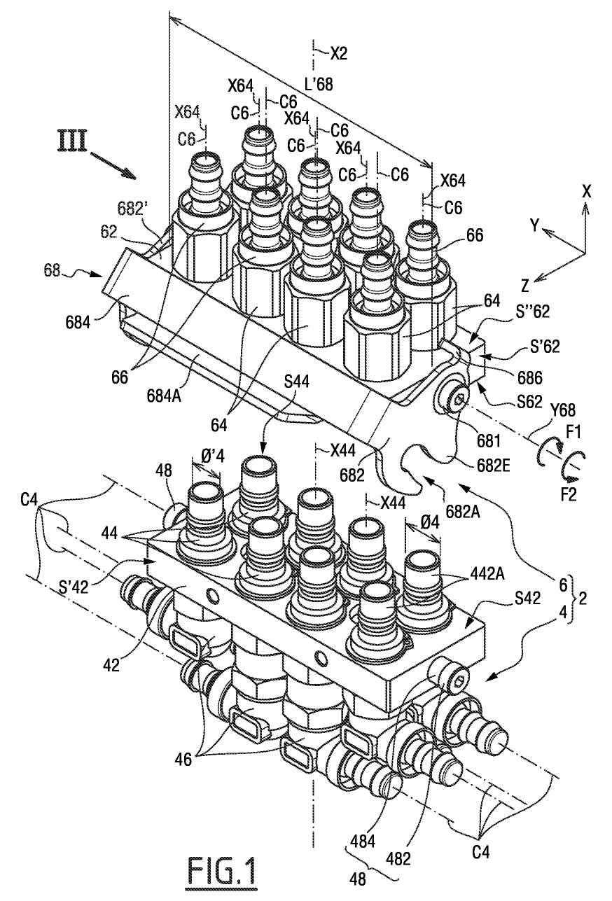

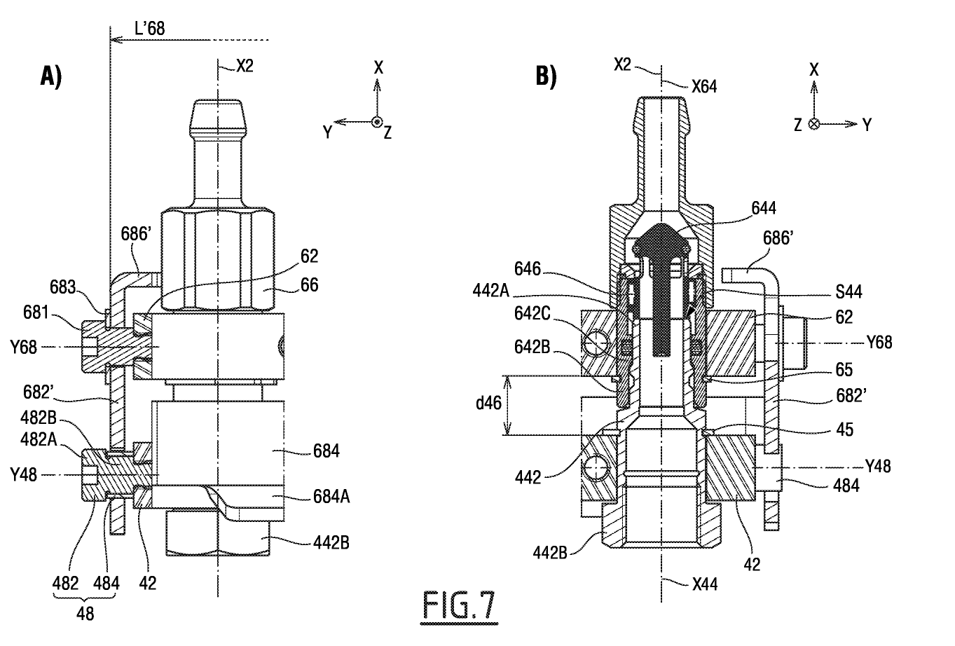

The multi-connector system 2 shown in FIGS. 1 - 6 and on inset A) of FIG. 7 comprises a receiving subassembly 4 and a supply subassembly 6 that are intended to be moved toward or away from one another by a translation of one of them along a connection axis X2.

XYZ denotes an orthogonal coordinate system associated with the multi-connector system 2. The connection axis X2 is parallel to the abscissa axis of the coordinate system XYZ, a transverse direction is parallel to the ordinate axis Y of the coordinate system XYZ. A depth direction is parallel to axis Z of the coordinate system XYZ.

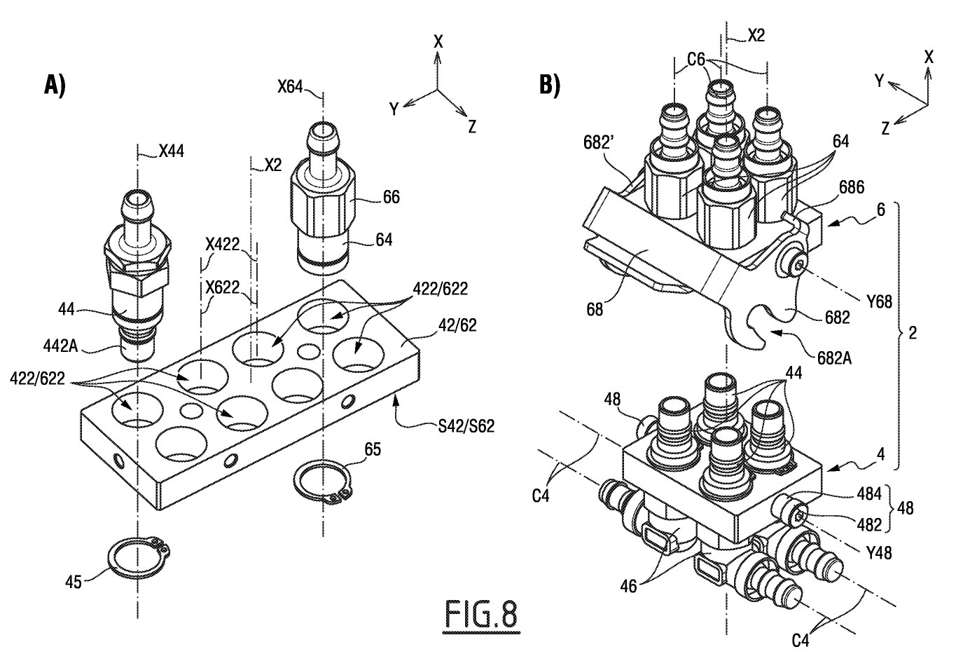

The receiving subassembly 4 comprises a first flat plate 42 on which eight male connector elements 44 are mounted distributed in two rows of four connector elements each extending transversely, in a direction parallel to axis Y of the coordinate system XYZ. Each male connector element 44 is received in a housing 422 of the first plate 42 which is in the form of a cylindrical bore of circular section, as visible on inset A) of FIG. 8 for the housings 422 of the third embodiment.

Each housing 422 is centered on a housing axis X422 parallel to the connection axis.

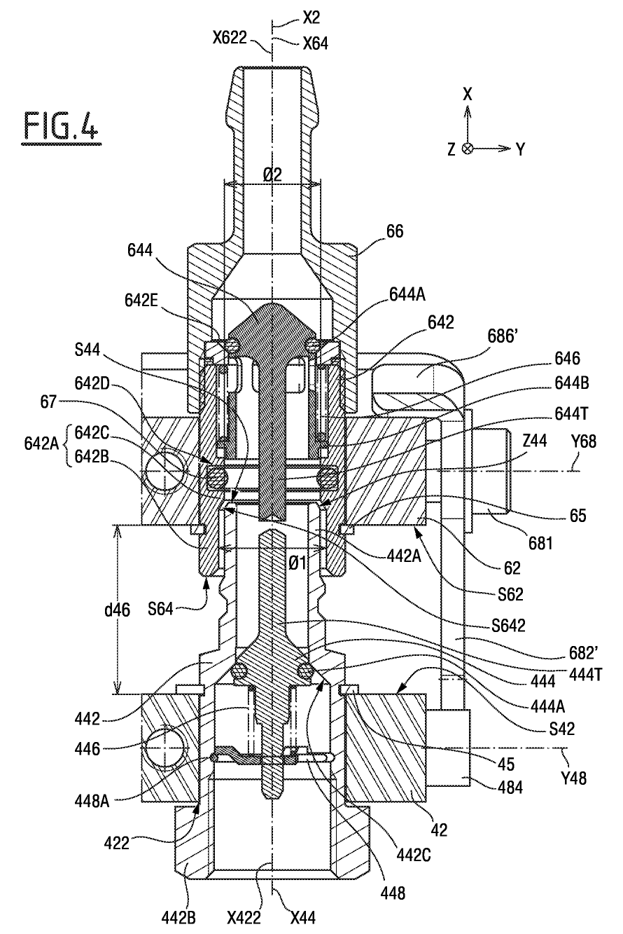

Each male connector element 44 extends along a longitudinal axis X44 and comprises a cylindrical body of circular section whose part received in a housing 422 of plate 42 has a diameter slightly smaller than the diameter of this housing. Thus, the longitudinal axis X44 of each male connector element 44 is parallel and close to axis X422 of the housing 422 in which it is received. Each connector 44 is mounted in a housing 422 of plate 42 with a possibility of movement, radial to longitudinal axis X44, of an amplitude determined by the difference of the diameters of the housing 422 and of the body 442. Each male connector element 44 is held in position in the corresponding housing 422 by means of a circlip 45 compatible with a movement of the body 442 in the corresponding housing 422, radially to axis X44 and to axis X422. In the nominal configuration of mounting of a male connector element 44 in a housing 422, axes X44 and X422 coincide, as shown in FIG. 4.

Each male connector element is connected to an angled element 46 that constitutes one end of a fluid circuit C4 for conveying a heat-transfer liquid to parts of an injection mold not shown.

The body 442 of each male connector element 44 comprises a nose 442A that constitutes a distal end of this connector element, as well as a threaded part 442B, opposite the nose 442A along longitudinal axis X44 and which is provided for screwing the angled element 46 thereto.

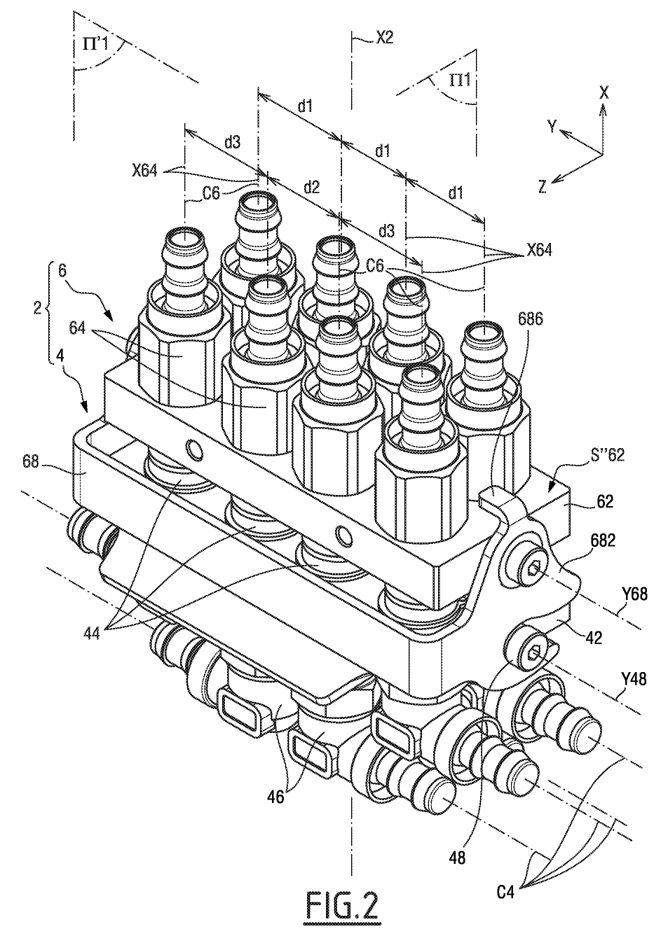

For the sake of clarity of the drawing, angled elements 46 are shown only in FIGS. 1 and 2, as are the fluid conduits C4.

The nose 442A of each male connector element 44 is tubular, of circular section centered on longitudinal axis X44. It defines a distal end surface S44 of the connector element 44 to which it belongs. Each distal end surface S44 is annular, flat and of circular section centered on longitudinal axis X44 of the male connector element 44 considered.

Φ4 denotes an external diameter of the nose 442A of a male connector element 44.

Φ’4 denotes an internal diameter of the nose 442A of a male connector element, which is the fluid passage diameter in the connectors formed by the male connector elements 44 and the corresponding female connector elements, in the connected configuration of these connector elements. Here, internal diameter Φ’4 is approximately 9 millimeters (mm).

S42 denotes a front surface of the first plate 42 facing toward the noses 442A of the connector elements 44 that it carries. Front surface S42 faces toward supply subassembly 6 during the connection of subassemblies 4 and 6.

Each connector element 44 also comprises a valve 444 equipped with a seal 444A intended to come to bear against a seat 442C formed by the body 442, under the action of an elastic return member 446 formed here by a coil spring bearing against a base 448 immobilized, along longitudinal axis X44, in body 442 by a circlip 448A.

S’42 denotes a peripheral surface of plate 42 that is of rectangular shape and that surrounds front surface S42. Peripheral surface S’42 comprises four sides. From two opposite sides of peripheral surface S’42 extend, in two opposite directions, two pins 48 that are aligned on a common transverse axis Y48 perpendicular to connection axis X2 and parallel to axis Y of the coordinate system XYZ. Pins 48 are arranged symmetrically on two opposite sides of first plate 42. Thus, pins 48 are fixed on plate 42, more particularly on the edge of this plate defined by surface S’42.

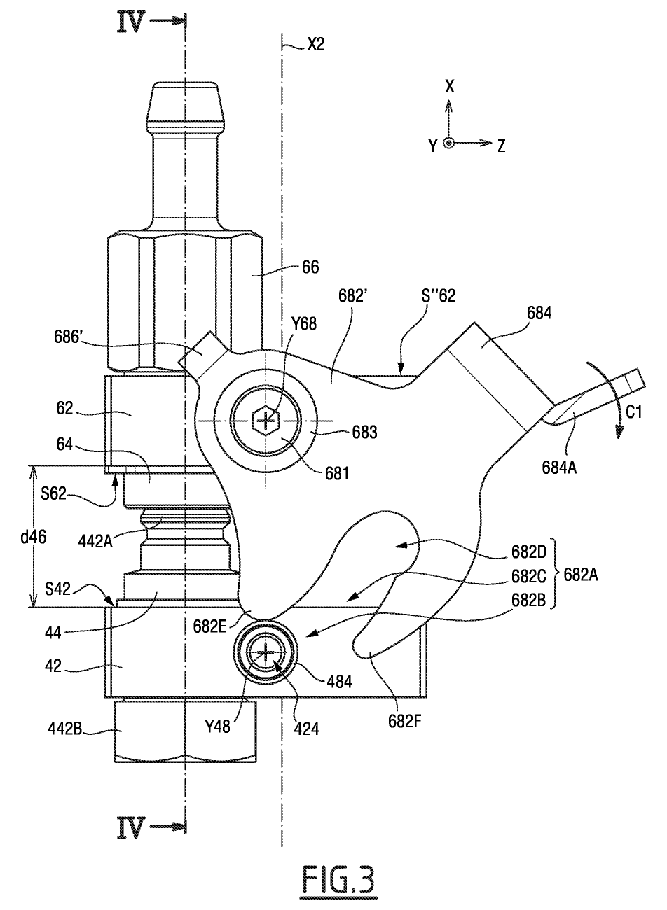

Each pin 48 is formed by a screw 482 with a circular head 482A and with a hollow hexagonal recess and by a sleeve 484 mounted around shank 482B of screw 482. Screws 482 are screwed into two threaded bores 424 that open onto two opposite faces of plate 42, corresponding to two opposite sides of peripheral surface S’42, in this case its smaller sides. For improved readability, screws 482 are not shown in FIGS. 3, 4, 5, 6 and on inset B) of FIG. 7, where only threaded bores 424 and sleeves 484 are visible.

Receiving subassembly 4 is devoid of specific means, in other words dedicated means, for pre-positioning, guiding or centering, such as pre-positioning, guiding or centering rods or bushings intended to cooperate with supply subassembly 6. In particular, first plate 42 does not carry specific pre-positioning members, nor specific centering members, which frees the entirety of front surface S42 for installing male connector elements 44 thereon. By specific is meant members that would serve only for the pre-positioning, guiding and/or centering of subassemblies 4 and 6 relative to one another, like the columns, bushings and edges of the prior art, which are not present in multi-connector system 2.

In particular, in the absence of specific means for pre-positioning, guiding or centering on receiving subassembly 4, distal end surface S44 of a male connector element constitutes the surface of receiving subassembly 4 that is farthest, from front surface S42, along connection axis X2.

Supply subassembly 6 comprises a second flat plate 62 of which S62 denotes the front surface facing toward receiving subassembly 4 during the connection of subassemblies 4 and 6. S’62 denotes a peripheral surface of plate 62 that is of rectangular shape, that surrounds front surface S62 and that comprises four sides.

Second plate 62 carries eight female connector elements 64 complementary to male connector elements 44 and each received in a housing 622 of plate 62 with a possibility of radial movement relative to a longitudinal axis X64 of the female connector element considered, according to the same arrangement as that mentioned above for male connector elements 44 and housings 422.

Each housing 622 is centered on a housing axis X622 parallel to the connection axis.

For the sake of clarity of the drawing, only one male connector element and only one female connector element are shown in FIGS. 3 - 6, as well as on inset A) of FIG. 7.

Each female connector element 64 comprises a tubular body 642 of circular section centered on its longitudinal axis X64 and which is retained in corresponding housing 622 by means of a circlip 65.

Body 642 of each female connector element 64 defines a distal end surface S64 of connector element 64 to which it belongs. Each distal end surface S64 is annular, flat and of circular section centered on longitudinal axis X64 of the female connector element 64 considered.

Supply subassembly 6 is also devoid of specific means for pre-positioning, guiding or centering, such as rods, bushings or edges intended to cooperate with receiving subassembly 4. In particular, plate 62 does not carry specific pre-positioning members, nor specific centering members, which frees the entirety of front surface S62 for installing female connector elements 64 thereon.

In particular, in the absence of specific means for pre-positioning, guiding or centering on the supply subassembly, distal end surface S64 of a female connector element constitutes the surface of supply subassembly 6 that is farthest from front surface S62, along insertion axis X2.

The mouth 642A of body 642, through which nose 442A of a male connector element 44 penetrates into body 642 during connection of these connector elements, has a stepped internal geometry, by being constituted of a first centering portion 642B, of which Φ1 denotes the internal diameter, and of a second sealing portion 642C, of which Φ2 denotes the internal diameter.

Diameter Φ2 is strictly smaller than diameter Φ1.

Furthermore, diameter Φ1 is strictly larger than diameter Φ4 of a nose 442A of a male connector element.

Δ1 denotes a difference between diameters Φ1 and Φ4. For a diameter Φ’4 on the order of 9 mm, this difference is advantageously between 0.1 and 0.5 mm.

In practice, diameter Φ2 is slightly larger than diameter Φ4, which allows a sealing engagement between nose 442 of a male connector element 44 and mouth 642A of a female connector element 64, at the level of second portion 642C, when nose 442A is received in second portion 642C.

Advantageously, in order to improve this sealing engagement, second portion 642C is equipped with an O-ring seal 67 received in an internal peripheral groove 642D of second portion 642C.

In a variant not shown, seal 67 may have a shape other than toroidal.

Connector element 64 also comprises a valve 644 equipped with a seal 644A intended to come to bear against a seat 642E formed by body 642. Valve 644 is returned by default into a closed position of female connector element 64 by an elastic return member 646, which is here constituted by a coil spring bearing against an internal ring 648 of female connector element 64 and against an external peripheral collar 644B of the valve.

An adapter 66 is attached on each female connector element 66, which makes it possible to connect a hose of a fluid circuit C6 thereto.

Fluid circuits C4 and C6 and connector elements 44 and 64 are compatible with the circulation of liquid or gaseous fluids.

The fluid circuits are shown, only in FIGS. 1 and 2, by center lines.

Advantageously, all male connector elements 44 are identical, as are all female connector elements 64. Thus, the above description for one male connector element 44 is generic of the male connector elements and the above description of one female connector element 64 is generic of the female connector elements.

Advantageously, for each pair of complementary connector elements 44 and 64, housing 422 for installing male connector element 44 in first plate 42 is identical to housing 622 for installing female connector element 64 of second plate 62.

Advantageously, first and second plates 42 and 62 are identical, which is advantageous in terms of production cost, ease of supply and management of spare parts.

The fact that each of male and female connector elements 44 and 64 is equipped with a valve 444, respectively 644, makes it possible to ensure that, upon disconnection of the connector elements of subassemblies 4 and 6, fluid circuits C4 and C6 respectively connected to these connector elements are isolated from the outside. This avoids the flow of fluids outside the fluid circuits.

The bores that constitute housings 422 and 622 are arranged in two rows parallel to axes Y48 and Y68. On the first row situated at the back of FIGS. 1 and 2, these housings are equidistant. Thus, longitudinal axes X64 of female connector elements 64 of the first row are separated pairwise by the same distance d1, measured parallel to axis Y68.

Moreover, housings 422 and 622 of the second row are not equidistant. Longitudinal axes X64 of female connector elements 64 arranged on the second row are separated pairwise by a distance that can take two different values d2 and d3. For example, distance d2 between the two longitudinal axes X64 of the two female connector elements 64 of the second row is strictly smaller than distance d3 between longitudinal axis X64 of one of the central female connector elements 64 and longitudinal axis X64 of a female connector element 64 situated at the end of the row.

Distance d3 may be equal to distance d1 but this is not mandatory.

As plates 42 and 62 are identical, the distribution of housings 422 and the distribution of longitudinal axes X44 of male connector elements 44 are also different, between the first and second rows of male connector elements.

Π1 denotes a median plane of one of plates 42 or 62 perpendicular to axis Y48 or Y68 and equidistant from the portions of surface S’42 or S’62 from which pins 48 extend. The distribution of housings 422 and 622 is symmetrical with respect to plane Π1. Π’1 denotes a median plane of plates 42 and 62 perpendicular to plane Π1. Median plane Π’1 contains transverse axis Y48 and an articulation axis Y68 mentioned below, when the connector elements are connected. Median plane Π’1 also contains connection axis X2. Housings 422 and 622 are arranged asymmetrically relative to plane Π’1.

Thanks to this arrangement of housings 422 and 622, it is not possible to make a mistake in direction when connecting male and female connector elements 44 and 64 of subassemblies 4 and 6, by moving first and second plates 42 and 62 together in translation along connection axis X2. Indeed, if plate 62 were rotated by 180° about connection axis X2 relative to its position of FIG. 1, then female connector elements 64 of the first row would be arranged facing male connector elements 44 of the second row and vice versa. In view of the difference of distances d1, d2 and d3, this would make a connection of the connector elements impossible.

Supply subassembly 6 also comprises an operating lever 68 articulated on second plate 62 about a transverse axis Y68. When connector elements 44 and 64 are in the process of being connected or connected, axes Y48 and Y68 are parallel.

Operating lever 68 comprises two side plates 682 and 682’ articulated on second plate 62 about axis Y68 and which are fastened together by a bar 684 from which an actuating tab 684A extends. Each side plate 682 or 682’ is extended in the direction of the other side plate by a stop 686, respectively 686’, which comes to bear against a rear surface S’’62 of second plate 62, which is opposite its front surface S62. By coming to bear against rear surface S’’62, stops 686 and 686’ limit a rotation of operating lever 68 about axis Y68 in the direction of arrow F1 in FIG. 1.

Advantageously, operating lever 68 is formed by cutting and bending a sheet-metal plate. Thus, operating lever 68 is robust and its cost price is low.

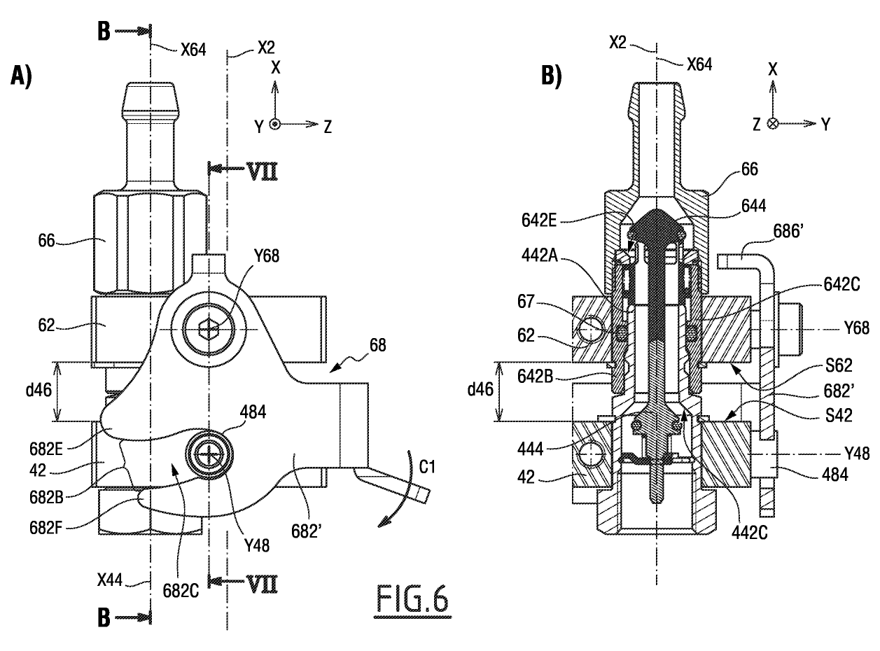

Each side plate 682 or 682’ comprises a groove 682A for receiving and sliding one of pins 48 during a tilting movement of operating lever 68 about axis Y68 in the direction of arrow F2 in FIG. 1, between a release position shown in FIGS. 1, 3 and 4 and a locking position shown in FIG. 2 and 6.

Each groove 682A is generally in the shape of an arc of a circle centered on axis Y68 and comprises a mouth 682B, a main part 682C and a terminal seat 682D. Mouth 682A is defined in width between a beak 682E and a tip 682F. In particular, beak 682E laterally delimits mouth 682B, on one side thereof.

Articulation axis Y68 is materialized by two screws 681, which are advantageously of the same type as screws 482 and which are screwed into two opposite sides of surface S’62, in this case its smaller sides. Thus screws 681 are fixed on plate 62, more particularly on the edge of this plate defined by surface S’62. The means for mounting and articulating operating lever 68 on second plate 62 also comprise two washers 683 interposed between the heads of screws 681 and side plates 682 and 682’.

L68 denotes a length, measured between side plates 682 and 682’ in the unstressed configuration of operating lever 68, that is to say when this operating lever is not mounted on second plate 62.

L’68 further denotes a length, measured between side plates 682 and 682’ parallel to articulation axis Y68, when operating lever 68 is mounted on second plate 62. Length L’68 is strictly smaller than length L68. In other words, operating lever 68 is mounted under axial stress between washers 683, which constitute means for braking operating lever 68 in its rotation about articulation axis Y68. Indeed, when it is mounted on second plate 62, operating lever 68 is elastically deformed and its elasticity generates a contact pressure on washers 683, this contact pressure having the effect of braking the lever in rotation about articulation axis Y68.

In a variant, other means for braking operating lever 68 in rotation about articulation axis Y68 may be provided, such as the use of spring washers put in place of washers 683. Furthermore, the braking means may be provided at the level of only one side plate 682 or 682’.

Because of the braking of operating lever 68, the latter remains in the angular position to which it is brought by a user and does not tend to pivot untimely, notably under the effect of its own weight, which would tend to exert on operating lever 68 a torque in the direction of arrow F2 in FIG. 1.

Under these conditions, operating lever 68 remains in the position shown in FIG. 1 when it has been pushed by a user until bringing stops 686 and 686’ to bear against surface S’’62.

In this position, called the release position, subassemblies 4 and 6 may be moved away from one another along connection axis X2 or, on the contrary, moved toward one another.

According to a variant not shown of the invention, in addition to or instead of the above-mentioned braking means, elastic return means of the operating lever into its release position may be incorporated into supply subassembly 6.

When it is appropriate to connect male and female connector elements 44 and 64 of receiving subassembly 4 and of supply subassembly 6, supply subassembly 6 is moved toward supply subassembly 4 by a translation along connection axis X2 with operating lever 68 in the position shown in FIG. 1, which has the effect of bringing each of side plates 682 and 682’ to bear by its beak 682E on a sleeve 684 of one of pins 48, in the configuration shown in FIGS. 3 and 4. In this configuration where pins 48 abut by their sleeves 484 against entry zones of grooves 682A formed by beaks 682E, a separation distance d46 between surfaces S42 and S62 of first and second plates 42 and 62, is fixed at a first value that depends on the geometry of side plates 682 and 682’, as well as on the positioning of pins 48 and of articulation axis Y68.

In this configuration, noses 442A of male connector elements 44 are engaged in mouths 642A of female connector elements 64 by penetrating into first portion 642B of these mouths, without being engaged in second portion 642C of these mouths.

As shown in FIG. 4, nose 442A of a male connector element 44 is received in mouth 642A of a female connector element 64 without being in contact with the internal surface of this mouth, because of the difference between diameters Φ1 and Φ4. Thus, in the event of a slight alignment defect between axes X44 and X64, there is no jamming between bodies 442 and 642.

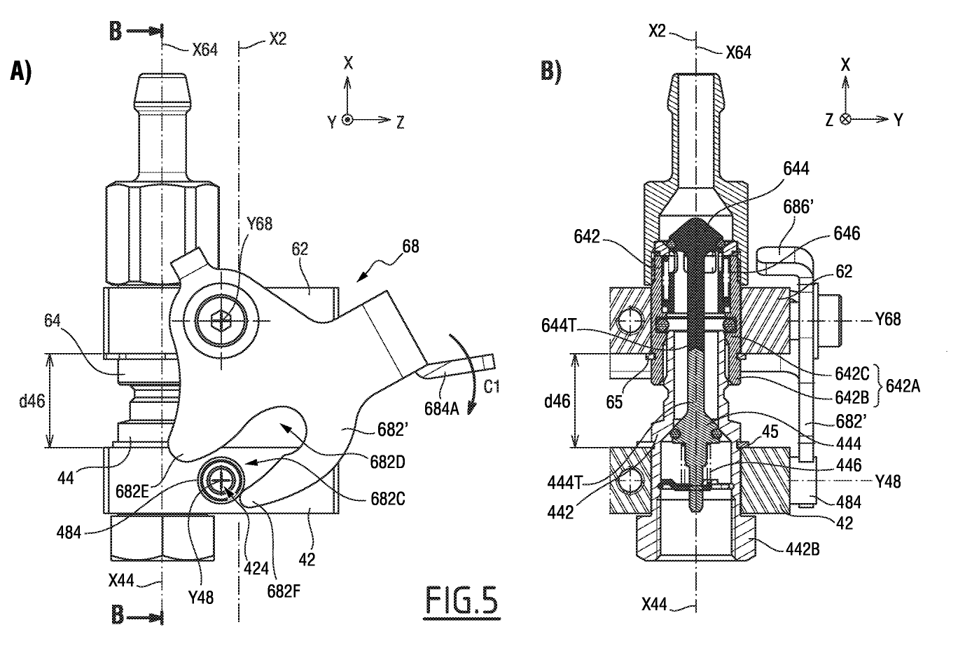

When a user exerts on actuating tab 684A of bar 684 a torque about axis Y68 shown by arrow C1 in FIG. 3, this has the effect of engaging grooves 682A of side plates 682 and 682’ around pins 48, therefore of causing the pins to penetrate into main parts 682C and of moving surfaces S42 and S62 closer together in order to reach the configuration of FIG. 5, where separation distance d46 has a second value, strictly smaller than that of the configuration of FIGS. 3 and 4. In the configuration of FIG. 5, nose 442A of a male connector element 44 is engaged in second portion 642C of mouth 642A of a female connector element 64, as shown on inset B) of FIG. 5.

The two valves 444 and 644 still bear, by their seals 444A and 644A, against their respective seats 442C and 642E, which means that the two connector elements 44 and 64 are still closed, even if stems 444T and 644T of these two valves are in contact with one another.

An internal transition surface S642 between first and second portions 642B and 642C of mouth 642A is frustoconical and convergent in the direction of second portion 642C, whereas a transition zone Z44 between distal end surface S44 and the ordinary external peripheral surface of nose 442A is chamfered. The cooperation of frustoconical surface S642 of female connector element 64 and of chamfered zone Z44 of male connector element 44 makes it possible progressively to guide nose 442A toward second portion 642C of mouth 642A, including in the event of misalignment between axes X44 and X64, during the passage from the configuration of FIGS. 3 and 4 to the configuration of FIG. 5. This induces, where applicable, a realignment of axes X44 and X64, which is possible thanks to a radial movement of bodies 442 and 642 of connector elements 44 and 64 within housings 422 and 622, as explained above.

The continuation of the pivoting of the operating lever under the effect of torque C1 moves side plates 682 and 682’ relative to pins 48, which arrive in terminal seats 682D at the end of this pivoting, as shown in FIG. 6. In this configuration, stems 644T and 644T push valves 644 and 444 into the open position.

In this configuration, operating lever 68 is in a locking position, in which pins 48 are locked in grooves 682A, at the level of terminal seats 682D. Plates 42 and 62 cannot be moved away from one another along connection axis X2. Fluid circuits C4 and C6 are connected to one another.

During the passage from the configuration of FIGS. 3 and 4 to the configuration of FIG. 6, passing through the configuration of FIG. 5, distance d46 is progressively reduced. For example, this distance may pass from a first value equal to 22 mm in the configuration of FIGS. 3 and 4 to a second value equal to 20 mm in the configuration of FIG. 5, then to a third value equal to 13 mm in the configuration of FIG. 6. This reduction of separation distance d46 has the effect of progressively causing nose 442A of each connector element 44 to penetrate into second portion 642C of mouth 642A of a corresponding female connector element 64, which allows a sealing engagement between the external peripheral surface of nose 442A and second portion 642C, in particular thanks to seal 67.

In the second to sixth embodiments, the elements analogous to those of the first embodiment bear the same references. If a reference is used in the remainder of the description without being shown in a figure or shown in a figure without being mentioned in the description, it denotes the same element as that bearing the same reference in the first embodiment. In what follows, what mainly distinguishes the second to sixth embodiments from the first embodiment is described.

In the second embodiment shown on inset B) of FIG. 7, male connector element 44 is devoid of a valve. In other words, during disconnection of subassemblies 4 and 6, only fluid circuits C6 are isolated from the outside. First and second plates 42 and 62 and female connector element 64 are identical to those of the first embodiment.

Here distal end surface S44 of male connector element 44 comes into contact with valve 644 of female connector element 64 to actuate it in an opening direction, against the action of an elastic return member 646, here a coil spring.

The third embodiment shown on inset A) of FIG. 8 differs from the preceding ones in that each of the receiving subassemblies comprises both male connector elements 44 and female connector elements 64, which is shown for only two of them. In other words, in this case, receiving subassembly 4 and supply subassembly 6 each comprise a plate 42 or 62 in housings 422 or 622 of which male connector elements 44 and female connector elements 64 are mounted.

In the fourth embodiment shown on inset B) of FIG. 8, the number of connector elements 44 or 64 of each receiving subassembly 4 and 6 is equal to four.

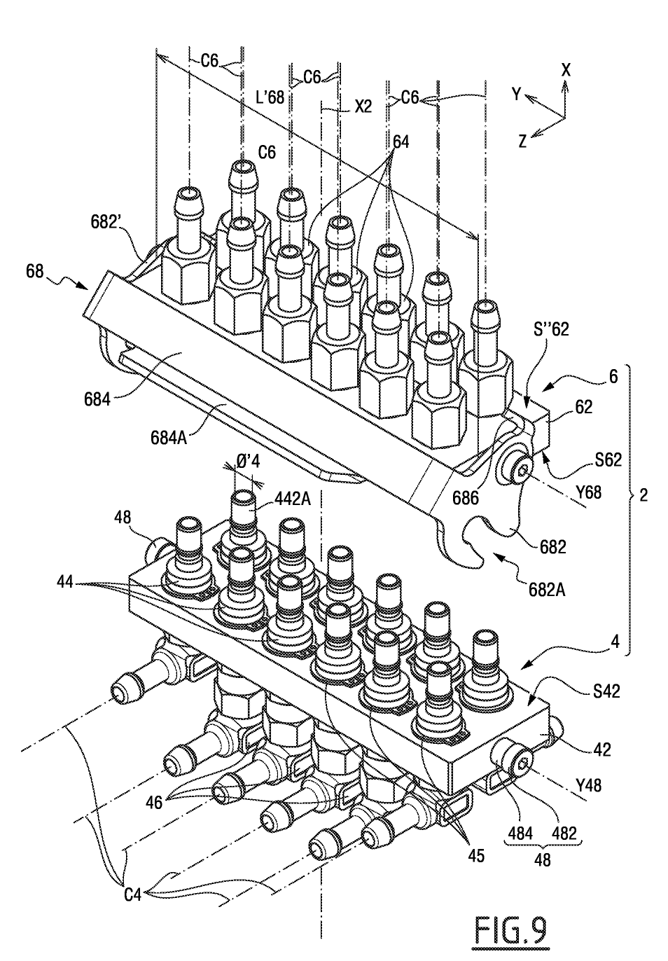

In the fifth embodiment shown in FIG. 9, the number of connector elements 44 or 64 of each subassembly 4 or 6 is equal to twelve.

In the fifth embodiment, internal diameter Φ’4 of nose 442A of a male connector element 44 is about 6 mm.

In the sixth embodiment, a foolproofing device 70 is incorporated into multi-connector system 2 and comprises a first strip 74 fixed on a longitudinal portion of peripheral surface S’42 of plate 42 and a second strip 76 of complementary shape fixed on a longitudinal portion of peripheral surface S’62 of second plate 62.

First strip 74 is provided with a notch 742 for receiving a tooth 762 formed on an edge of second strip 76 facing toward receiving subassembly 4 when subassemblies 4 and 6 are moved toward one another along connection axis X2 for the connection of male and female connector elements 44 and 64.

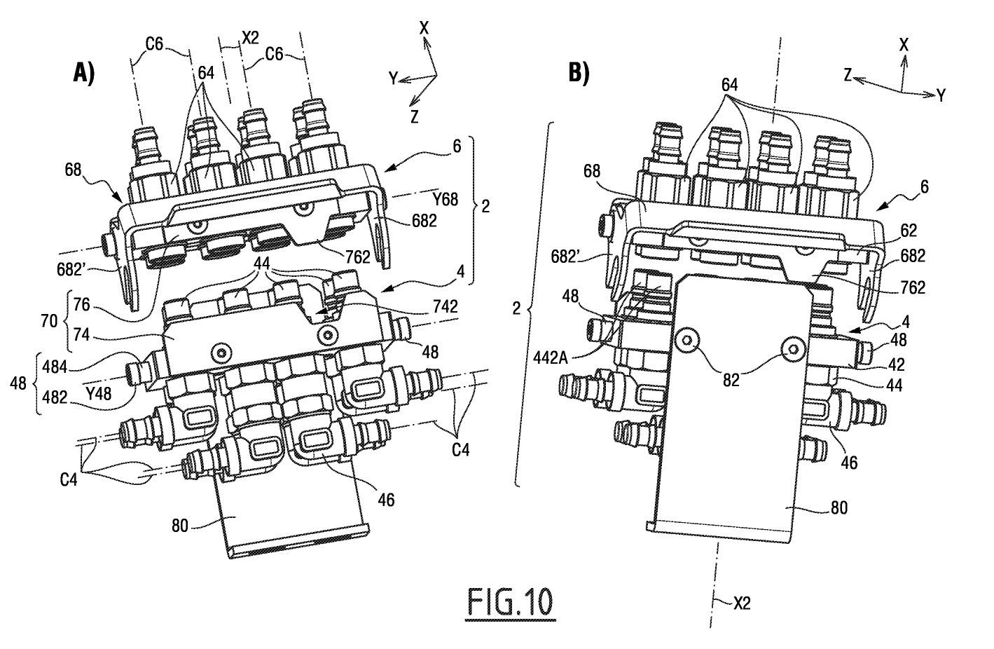

When plates 42 and 62 are correctly oriented relative to one another around connection axis X2, as shown on inset A) of FIG. 10, tooth 762 of second strip 76 can be received in notch 742 of first strip 74. The foolproofing device does not oppose the connection of male and female connector elements 44 and 64.

On the other hand, if the orientation of the first and second plates is reversed, as shown on inset B) of FIG. 10 where the receiving subassembly is rotated by 180° around connection axis X2 relative to the configuration of inset A), tooth 762 of the second strip comes to bear against a support 80 on which first plate 62 is mounted by means of two screws 82, this support serving for mounting receiving subassembly 4 on the body of an injection mold not shown.

Thus, in the configuration of inset B) of FIG. 10, it is not possible to connect connector elements 44 and 64 to one another.

In a variant, first strip 74 may be mounted on second plate 62, whereas second strip 76 is mounted on first plate 42.

The invention is shown in the figures in the case where subassembly 4 is the receiving subassembly and subassembly 6 is the supply subassembly. However, the reverse is possible.

The invention finds a particularly advantageous application in the plastics processing field, for the connection of heat-transfer fluid circuits making it possible to control the temperature of injection molds. It is however applicable in all industrial fields involving liquid or gaseous fluids for the production of goods, handling or temperature regulation.

The technical features mentioned above for one embodiment or one variant may be applied to the other embodiments and variants, insofar as this is technically possible.

What is claimed is:

1. A multi-connector system for the simultaneous connection of fluid circuits along a connection axis, by means of male connector elements and female connector elements, this system comprising:
a first subassembly including;
a first plate;
several first connector elements installed in housings of the first plate;
two pins extending along a first transverse axis perpendicular to connection axis and arranged symmetrically on two opposite side of the first plate;
a second subassembly including;
a second plate;
several second connector elements, complementary to the first connector elements, installed in housings of the second plate and configured to connect to the first connector elements of the first subassembly, in order to connect the fluid circuits to one another;
an operating lever equipped with two lateral side plates articulated on the second plate about an articulation axis perpendicular to connection axis, each having a groove for receiving and sliding of a pin of the first subassembly and movable in rotation about articulation axis, between a locking position, in which the pins are locked in the grooves and the fluid circuits are connected to one another, and a release position, in which the first subassembly and the second subassembly can be moved away from one another along the connection axis;
a distal end of each male connector element comprising a cylindrical tubular nose;
wherein;
the first plate and the second plate are devoid of specific means for pre-positioning, guiding or centering a movement of approach of the first and second plates during the connection of the first and second subassembly;
a mouth of a female connector element comprises a first centering portion having a first diameter and a second sealing portion having a second diameter;
the second diameter is strictly smaller than the first diameter; and
when the side plates of the operating lever are in the release position and the pins abut against entry zones of grooves of the side plates, tubular nose of a male connector element is received in first portion of mouth of a female connector element, without being engaged in second portion of this mouth.

2. The multi-connector system according to claim 1, wherein a surface of a subassembly that is the farthest from a front face of plate of this subassembly is formed by a distal surface of nose of a male connector element or by a distal surface of mouth of a female connector element.

3. The multi-connector system according to to claim 1, wherein each side plate comprises a beak that laterally delimits a mouth of groove of the side plate and wherein, when operating lever is in the release position and abutting against the pins of first subassembly, beak of each side plate bears against a pin, by defining a first value of a separation distance of first and second plates along connection axis.

4. The multi-connector system according to claim 1, wherein connector elements are mounted with radial play in housings of first plate and/or of second plate.

5. The multi-connector system according to claim 1, wherein housings of the two plates are arranged asymmetrically relative to a median plane of the plates containing transverse axis and connection axis.

6. The multi-connector system according to claim 1, wherein a female connector element comprises a valve biased into a closed position by an elastic return member and pushed into an open position by the complementary male element when side plates of the operating lever are moved from their release position toward their locking position and, preferably, a male connector element comprises a valve biased into a closed position by an elastic return member and pushed into an open position by the complementary female element, when the side plates of the operating lever are moved from their release position toward their locking position.

7. The multi-connector system according to claim 1, wherein at least one articulation of operating lever on second plate is equipped with means for braking rotation of operating lever about articulation axis.

8. The multi-connector system according to claim 1, wherein for each pair of complementary connector elements, the housing for installing first connector element in first plate is identical to the housing for installing second connector element of second plate.

9. The multi-connector system according to claim 8, wherein first and second plates are identical.

10. The multi-connector system according to claim 1, wherein the first connector elements are male connector elements and the second connector elements are female connector elements or the first connector elements comprise both male connector elements and female connector elements and the second connector elements comprise both female connector elements and male connector elements.

11. The multi-connector system according to claim 1, wherein the first plate and the second plate each carry between four and twelve connector elements.

12. The multi-connector system according to claim 1, comprising a foolproofing device for the relative orientation of first and second plates around connection axis, this foolproofing device including two strips of complementary shapes each mounted on one side of the first and second plates.

13. The multi-connector system according to claim 1, wherein the pins are fixed on first plate, preferably on an edge of this plate, and wherein members materializing articulation axis of lateral side plates are fixed on second plate, preferably on an edge of this plate.
